(19) United States
(12) Patent Application Publication
(10) Pub. No.: US 2021/0117954 A1
(43) Pub. Date: Apr. 22, 2021

(54) MODERN CHECKOUT

(71) Applicant: Steven R. Schwartz, Fort Lauderdale, FL (US)

(72) Inventor: Steven R. Schwartz, Fort Lauderdale, FL (US)

(21) Appl. No.: 16/658,157

(22) Filed: Oct. 21, 2019

(51) Int. Cl. G06Q 20/32; G07F 17/40; G06Q 30/06; G06Q 20/40

(52) U.S. Cl. CPC G06Q 20/32; G07F 17/40; G06Q 20/401; G06Q 30/0619; G06Q 30/0609

(57) ABSTRACT

A vending system allows customers to interact with a vendor using their mobile device, without having any prior relationship with the vendor and without the vendor installing any custom payment hardware. With the ubiquitous nature of mobile devices, such as cell phones, and the access of nearly all vendors to the Internet, each party already has everything it needs to establish a payment relationship without custom hardware at the vendor. Customers also have no reason to wait for an employee to allow paying a bill, such as at a bar or restaurant, when the customer is ready to leave. The system can also be used for ordering without waiting for an employee of the vendor to take an order. Thus, the vending system allows vendors and customers to interact with much less friction, providing a faster and more pleasing experience for the customer without any downsides for the vendor.

### BACKGROUND

There have historically been several common ways to pay for goods and services, such as when dining out at a restaurant or bar. Examples are cash, credit card, check, gift cards, and so on. Innovation around credit cards has mainly been in the area of detecting counterfeit cards, such as through the addition of a secure chip, and adding more convenient ways to use the card, such as contactless readers that use near-field communication (NFC) hardware to detect the card's presence and stored information. Cash has remained largely unchanged since the last century, though continued improvements have been made in the printing of paper money to detect and prevent counterfeiting. Vendors may also choose to not accept larger bills to reduce the likelihood of counterfeiting.

Newer payment methods have largely followed the paradigms established by the older payment methods. For example, PayPal allows a digital transfer of payments from a credit card or bank account, while services like Google Pay or Apple Pay allow the use of a mobile device such as a cell phone instead of a credit card, but largely charge the same card that the user might have used in the past. More recently, Apple has introduced its own credit card and enhanced its service with an Apple Pay Cash option, but these work largely in the same manner as past payment methods.

Restaurants have largely had the same type of transaction for centuries. A customer enters the restaurant, is seated at a table, and interacts with a waiter/waitress to order food, be presented with a bill, submit payment, and receive a receipt. The bill can often be paid with many or all the above-described payment methods. However, the customer is still subject to interacting with the restaurant through the waiter/waitress. If the restaurant is busy and the service is slow, the customer may wait a long time just to pay his or her bill.

More recently, some restaurants like Chili's have installed terminals called a Ziosk that provide a kiosk experience for paying the customer's bill. These systems require that the restaurant invest heavily in ordering hardware for each table, setting up the Ziosk to interact with the restaurant's point of sale (POS) system, teaching waitstaff how to determine when customers have and have not settled their bill before leaving, and teaching employees how to maintain the machines by adding paper, charging the machines each night, and so on. The kiosks often are not properly synchronized with the customer's bill, run out of paper for printing receipts, run out of charge, and so forth, making them unavailable at the time customers want to use them.

### BRIEF DESCRIPTION OF THE DRAWINGS

FIG. 1 is a block diagram that illustrates components of the vending system, in one embodiment.

FIG. 2 is a flow diagram that illustrates processing of the vending system to interact with a customer through a customer software application running on a mobile device of the customer, in one embodiment.

FIG. 3 is a flow diagram that illustrates processing of the vending system to interact with a vendor through a vendor software application, in one embodiment.

### DETAILED DESCRIPTION

A vending system is described herein that allows customers to interact with a vendor using their mobile device, without having any prior relationship with the vendor and without the vendor installing any custom payment hardware. With the ubiquitous nature of mobile devices, such as cell phones, and the access of nearly all vendors to the Internet, each party already has all the hardware it needs to establish a payment relationship without custom hardware at the vendor. Customers also have no reason to wait for an employee to allow paying a bill, such as at a bar or restaurant, when the customer is ready to leave. The system can also be used for ordering without waiting for an employee of the vendor to take an order.

In some embodiments, the customer downloads a custom application to his or her mobile device that uses global positioning system (GPS) hardware of the customer's mobile device to detect the customer's location, determine a vendor that the customer is frequenting, and present the customer with options for interacting with the vendor, such as by ordering and/or paying a bill. The customer may also scan a QR code or barcode at the table or on the bill to select the vendor and identify the customer. The vendor can configure a profile with the application provider that determines information that is shown in the custom application. For example, when the vendor is a restaurant, the vendor might request that the application obtain a table number from the customer so that the vendor knows which customers have paid through the application and which have not. Some vendors may choose to expose a menu through the custom application. Following is an example scenario using the vending system.

A customer walks into a restaurant, sits down at a table, and opens the customer application of the vending system. The application detects which restaurant the customer is visiting (e.g., by detecting the customer's location or asking the customer to scan a QR code at the location), and presents a menu previously configured by the vendor to offer the vendor's items. The application may also ask the customer to enter a table number, which the vendor has clearly labeled where the customer is sitting if the application has not already detected this through QR code or other method. The application receives an order from the customer, then forwards the order and table number to the vendor. The vendor receives the order, prepares the order, and delivers it to the specified table. The system may also provide other intermediate information, such as notifications to the customer that the vendor has received the order, and status updates along the way while the order is being prepared, such as when cooking has finished and a waiter or waitress is bringing the order out. When the customer is ready to leave, the customer can open the application again and provide payment through any of the payment methods offered by the vendor. The application receives the payment and provides it to the vendor, potentially with a fee subtracted to pay the operator of the application.

On the backend, the vending system may communicate at various steps with the vendor's point of sale system, through optional point of sale integration. This allows the vending system to update the point of sale system with orders for items and payments, and to receive information from the point of sale system, such as status updates, order acceptance, payment confirmation, and so forth. The customer may also be able to summon waitstaff at the vendor through integrated communication from the customer to the custom application, then from the backend of the vending system to the vendor's point of sale system, and ultimately to the waitstaff.

Unlike today, the customer has been able to get his or her order faster and leave whenever he or she was ready to go. At no time did the customer have to wait for employees of the restaurant, other than for food preparation time or drink refills. The vendor did not have to use any custom hardware, but rather logged on to a simple website or ran a custom vendor software application to configure a profile that provides the vendor's location, optionally enter a menu to offer to customers, enter custom information to request from customers (e.g., a table number or generate a QR code to display to customers), and then receives payments. Customers can make payments using any commonly accepted payment method configured in the application, such as credit card, cash (e.g., bank transfer), or digital payments. Thus, the vending system allows vendors and customers to interact with much less friction, providing a faster and more pleasing experience for the customer without any downsides for the vendor.

In some embodiments, the vending system provides a vendor application that a representative of each vendor runs to set up vendor information. The application may be a desktop application, mobile device application, web application, or other common format of software applications. The application may have a verification step, such as sending a postal mail letter to the vendor with a code that the vendor must enter to modify their profile. This provides some validation that the representative accessing the vendor application does in fact control or have a reasonable association with that location. The vendor optionally accesses the vendor application to set up custom product and service offerings, such as a menu of food items offered by vendor. The vendor may also access the application to track customers, such as viewing orders received through the application, customer location information, and any additional information entered by customers, such as a table number. The vendor may also receive payments and view payment history through the vendor application. In addition, vendors may request follow up information from customers such as a post-transaction survey to make sure the customer was satisfied by his or her interaction with the vendor. The vendor may also configure offers in the vendor application to entice past customers to return to visit the vendor and make new purchases, such as by offering a digital coupon that the customer can apply in the customer application while at the restaurant.

In some embodiments, the vending system makes other difficulties more convenient. For example, the application run by customers may provide tipping calculation and automatic splitting of a bill between multiple customers. In some cases, multiple customers may run the application on their individual mobile devices to each pay his/her part of the bill. Payment can be made through vouchers, credit cards, debit cards, loyalty points earned, and cash. Loyalty points can be configured by vendors in the vendor application and offered to users for preforming various actions (e.g., ordering a specific amount in one visit or specific items).

The vending system removes the hardware dependency currently experienced by most restaurants. Because only waitstaff typically have access to order entering and payment hardware, in the past only the waitstaff can place an order or receive a payment. Without this dependency, customers can place orders and make payments on their own, and waitstaff can focus on delivering food and providing a great experience. Even more recent systems that allow customers to pay at the table involve the installation of a kiosk at the table that is essentially a customer terminal for the POS system. When the kiosk does not work or if the vendor does not want to buy and maintain a kiosk for each table, there is no advantage offered by these systems to the customer. The vending system described herein removes this hardware dependency and vendor expense by leveraging available and ubiquitous customer hardware, such as smartphones and other mobile devices, to let the customer make payments and optionally place orders for products and/or services.

In some embodiments, the application can make many decisions automatically based on GPS information and artificial intelligence (AI). For example, when a customer opens the application, the application can detect where the customer is and ask the customer if he or she wants to place an order, then offer a menu to do so. The application can also provide item recommendations based on reviews from other customers and promotions offered by the vendor. Once a customer selects an item, the application can suggest other items that are often paired with that item. Later in the customer's visit, the application can suggest other things the customer may want, such as a drink refill or dessert. The application may suggest offers and discounts based on the customer's previous choices. The application may report loyalty points to the customer based on vendor configured rules. The application can also apply automatic payments when a customer leaves a location if the customer has previously authorized automatic payments. This allows the customer to simply get up and leave when the customer is ready, and the application will see to it that the vendor is properly paid for the items the customer ordered. When automatic payments are not available, the customer can still use the application to manually make a payment using many different payment methods (e.g., bank transfer, credit card, digital payment, and so on).

Vendors may add additional information to the vending system through the vendor application, such as specialty items, promotions, post transaction surveys, and so forth. The vendor may also offer a “call waiter” feature that allows a customer to summon waitstaff through the customer application. In addition, vendors may configure related services, such as an ability at a bar to call a taxi for a ride home from the bar. Vendors may also request that users share information to social media about the vendor and may provide links in the customer application for the customer to do so. The vendor may allow the customer to record live testimony, such as a video to share with friends.

In some embodiments, the vending system provides social features that allow customers to interact with and track their friends. For example, a customer may get a restaurant suggestion by looking in the customer application at where the customer's friends have eaten previously or may be eating currently. Customers may also share experiences with their friends about visits to various vendors.

In some embodiments, vendors can integrate the vending system with their existing POS system. Although it is desirable for the system to be usable without needing to install custom hardware, additional benefits can be achieved when the vendor is willing to connect the POS system and vending system. This allows synchronization of activity tracked by the vending system with the POS system, such as customer orders and payments. In this way, waitstaff used to using the POS system can continue to use the POS system to view orders, see who has paid their bill, view received tips, and so forth.

In some embodiments, the vending system maintains an account for customers to which the customers or related people (e.g., a parent on behalf of a child) can add funds with which to pay for goods or services through the customer application. Funds may be added through any of the previously described payment methods but are then maintained by the vending system in a manner chosen by the operator of the system. This can allow customers to make future payments without allowing the customer application to save credit card information or request new funds from the customer at the time of payment.

In some embodiments, the vending system provides paper scanning features through which the customer can scan a paper bill provided by a vendor not yet configured with the system. Whether such a vendor will allow payment through the system depends on the vendor's own preferences. The system may also provide QR/barcode scanning capabilities through which customers can access user account information, share a bill, and so forth.

In some embodiments, the vending system provides additional layers of security through biometric user authentication. This may include fingerprint identification, face recognition, retinal scanning, and voice recognition. The customer may be asked by the customer application to authenticate before accepting an order or making a payment. This provides additional verification that the customer's mobile device has not fallen into bad hands and that purchases made through the application are properly authorized by the customer.

In some embodiments, the vending system receives a location from the customer that identifies a vendor that the customer wants to purchase from without being at that location. This can be used for placing online orders where the customer will visit the vendor to make a purchase at some time soon. For example, from home a customer may enter the name of a restaurant, receive a menu, select items to order, and then place an order before leaving his or her home to go pick up the order. The customer may also request delivery and not leave his or her home at all to receive the order.

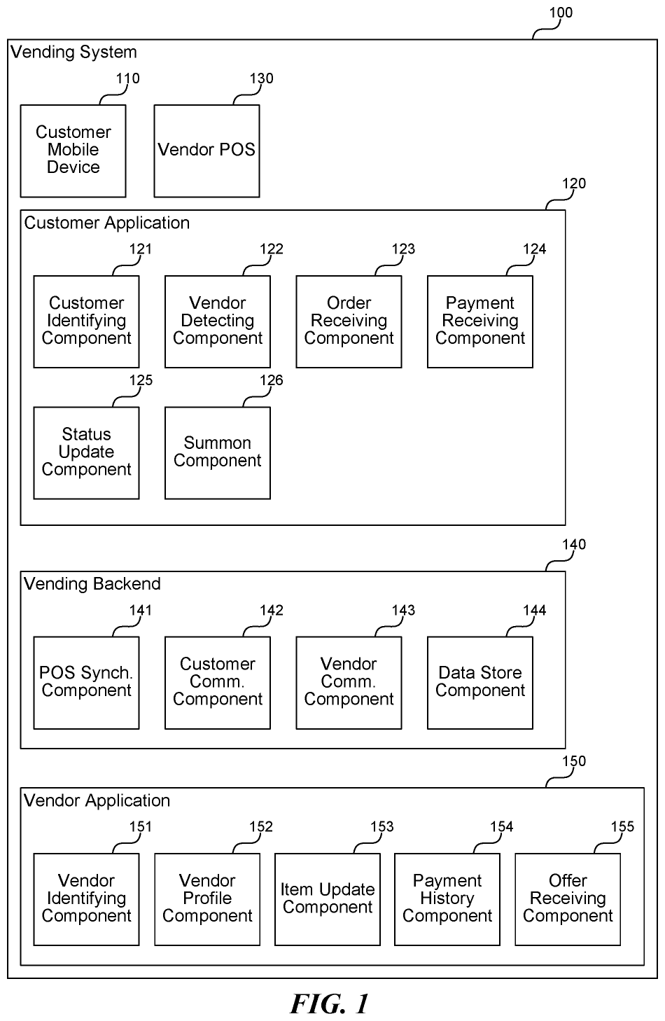

FIG. 1 is a block diagram that illustrates components of the vending system, in one embodiment. The system 100 includes a customer mobile device 110, a customer application 120, a vendor POS 130, a vending backend 140, and a vendor application 150. The customer application 120 includes a customer identifying component 121, a vendor detecting component 122, an order receiving component 123, a payment receiving component 124, a status update component 125, and a summon component 126. The vending backend 140 includes a POS synchronization component 141, a customer communication component 142, a vendor communication component 143, and a data store component 144. The vendor application 150 includes a vendor identifying component 151, a vendor profile component 152, an item update component 153, a payment history component 154, and an offer receiving component 155. Each of these components is described in further detail herein.

The customer mobile device 110 is a mobile device brought to a vendor's business location by a customer. The customer mobile device 110 can be a smartphone, tablet computer, smartwatch, portable MP3 player, or other mobile device that is capable of running applications, accessing the Internet, and may include specialized hardware such as a GPS radio, NFC contactless communication device, Bluetooth hardware, and other systems. The customer mobile device 110 is controlled by the customer and is differentiated from vendor managed and installed hardware such as might be found in a business location like a cash register, payment kiosk, POS terminal, and so forth. Unlike these vendor managed hardware items, the customer mobile device 110 is brought in and controlled by the customer and leaves with the customer. This provides the important advantage that a vendor can leverage something the customer carries to interact with and communicate with the customer without installing or managing hardware at the vendor's business location.

The customer application 120 is a software application run on the customer mobile device 110 that the customer uses to access the vending system 100. The customer application 120 may be a mobile application, such as an Apple iOS or Android application, a web-based application, a Windows application, or any other type of application accessible via a mobile device to provide features described herein. The customer application 120 is responsible for the customer's side of the communication with the vending system 100, including identifying who the customer is and accessing any stored customer profile with payment and other options, detecting which vendor the customer is interacting with, optionally receiving an order for goods/services from the customer, receiving payment from the customer to the vendor, providing any status updates from the vendor to the customer, and optionally allowing the customer to summon a representative of the vendor to handle other needs of the customer, such as receiving a drink refill or checking on a late order.

The customer identifying component 121 identifies the customer when the customer runs the customer application 120. Identifying the customer includes accessing a customer profile stored by the vending system and authenticating the customer. The customer profile may include preferences of the customer, payment options set up by the customer, loyalty programs that the customer is a member of, demographic information describing the customer, and so forth. Authenticating the customer includes using available information to determine that the customer is who he or she claims to be, to avoid fraudulent transactions or access to the customer's profile by someone other than the customer. Authentication may include using custom hardware of the customer mobile device 110, such as Apple Face ID, Apple Touch ID, password, biometric information (voiceprint, fingerprint, retina scan, and so on), two-factor authentication (e.g., texting a code to a phone number associated with the customer), and so forth. Once the customer is identified and authenticated, the customer application 120 can present the customer's profile to the customer and offer options for interacting with nearby vendors.

The vendor detecting component 122 detects the vendor that the customer is visiting to make a purchase. Visiting generally includes physically being present at the vendor's location but may also encompass remote visits such as when a customer is mobile ordering, ordering in advance of visiting the vendor, placing an order for delivery, and so forth. For physical visits, the vendor detecting component 122 may use GPS hardware and software features of the customer mobile device 110 to determine vendor locations near the customer's present location. The component 122 may also ask the customer to scan something at the vendor location, such as a QR code, barcode, image, or other item or to type a code that uniquely identifies the vendor location. Once the vendor is detected, the customer application 120 can present options for that vendor to the customer, such as a menu user interface, payment user interface, feedback user interface, summoning user interface, and so forth.

The order receiving component 123 optionally receives an order for goods or services from the customer to the vendor. Some vendors may not choose to expose a menu of items through the vending system 100, so this component 123 provides an optional feature. For those that do, the order receiving component 123 can present options for ordering to the customer, receive order information such as item selection, item quantity, any special instructions for preparation of the item, and so forth. The order receiving component 123 may receive an order with multiple items, such as a dinner and drink selection for each person at a restaurant table or may receive items for individual people. The component 123 provides a confirmation process in which the customer indicates that the order is complete, correct, and is ready to send to the vendor. At that point the component 123 sends the order through the vending system 100 to the vendor for fulfillment of the order.

The payment receiving component 124 receives a payment from the customer to the vendor. The payment receiving component 124 may access the vending system 100 to communicate with the vendor to receive a total that the customer owes as well as options for tipping, applying coupons, and splitting a bill. Manual payments occur when the customer accesses the customer application 120 to pay a bill at the end of a visit to the vendor's business location. For example, at a restaurant or bar the customer may become ready to leave, open the application 120 on his or her mobile device 110, select a payment method (gift card, loyalty points, credit card, digital payment account, and so on), confirm a payment amount, and authorize the payment.

In response, the payment receiving component 124 takes the steps to send the payment to the vendor. For a credit card this may include accessing an API for sending payments via the credit card company. For accounts managed by the system 100 (such as a child account managed by a parent or a gift card), this may include deducting the amount from the customer's account and adding the amount to the vendor's account. The payment receiving component 124 may also receive other information, such as an image of a customer signature swiped on a touch screen of the customer mobile device 100 or other authentication options to verify that the customer legitimately made the payment.

Automatic payments occur when a customer has pre-authorized payment and the system 100 detects that a payment is due. This may occur when the system 100 detects that the customer is leaving the vendor's business location. The customer may not need to take any manual steps other than walking out with his or her mobile device 110, and the system 100 will automatically obtain the total from the vendor, submit payment using the preauthorized method, and notify the customer that the payment has been made. This can help vendors who sometimes are not paid when customers accidentally leave a location and forget to pay their bill, and it can also help customer by freeing them from thinking about remembering to pay the bill.

The status update component 125 optionally provides status updates between the vendor and the customer. For example, the system 100 may allow the vendor to provide updates as the customer's order is prepared, and the system 100 provides updates to the customer at intervals such as receiving an order, items preparing (e.g., cooking), items being delivered, a payment being due, and so forth. The vendor may also receive notifications about the customer, such as a favorite customer arriving at the vendor's location, an order being received, a payment being received, a new review being posted publicly by a customer, and so forth.

The summon component 126 optionally allows the customer to physically summon a representative of the vendor to handle a customer need. For restaurant's, this may mean that the customer needs a waitperson to visit his or her table to handle something that cannot be handled digitally through the customer application 120, such as refilling a drink, taking back a mis-prepared food item, handling other mistakes, a customer wanting to meet the cook or owner to pay a compliment, and so on.

The vendor POS 130 is a pre-existing system already installed at the vendor business location that the vendor uses to enter orders and receive payments. Some POS systems also handle table management, tip distribution to waitstaff, employee scheduling, and so forth. POS systems are available from many sources, such as Toast POS, Lightspeed POS, NCR, IBM, and many other sources. Newer POS systems may offer a kiosk that the vendor can install at the business location but doing so often comes at significant cost in terms of time and money to install and manage the kiosk at the vendor location. The vending system 100 described herein may integrate with a vendor's existing POS 130 but does not require the installation or management of custom hardware at the vendor and rather relies on customer managed hardware brought in by the customer, such as a smartphone.

The vending backend 140 provides backend services for the vending system 100 to communicate between the customer application 120 and vendor application 150 and to persist data between sessions between the customer and vendor. The vending backend 140 may run on a computer server, a cloud-hosted service, or other common backend infrastructure and runs custom software to perform the functions of the vending system 100. The vending backend 140 uses a network to provide access to the vending system 100 via the Internet so that customers and vendors with a connection to the Internet can easily access the vending system 100.

The POS synchronization component 141 synchronizes data between the vending system 100 and the vendor POS 130. Synchronization may include communicating orders received, payments that have been made, status information between customer and vendor, exposing items for sale by the vendor, and so on. The component 141 may perform a periodic, scheduled synchronization or may include push features for the POS 130 and/or vending system 100 to inform the component 141 that updated information is available and should be accessed and synchronized.

The customer communication component 142 handles communication between the vending backend 140 and the customer application 120. The customer application 120 uses the vending backend 140 to communicate from the customer to the vendor, and to receive information from the vendor to the customer. Communication for this and other components described herein may occur through any available protocols, such as a RESTful web-based application-programming interface (API), traditional networking protocol (e.g., customer TCP or UDP protocol, and so forth.

The vendor communication component 143 handles communication between the vending backend 140 and the vendor application 150. The vendor application 150 uses the vending backend 10 to communicate from the vendor to the customer, and to receive information from the customer to the vendor. Communication can occur using any available protocol as described above capable of conveying the types of information described herein.

The data store component 144 persists data in between customer and vendor sessions with the vending system 100. The data store stores customer and vendor profile information, a log of previous activity (e.g., payments, orders, logon attempts, and so on), items available from each vendor, payment methods of each customer, authentication information, payment pre-authorizations from customers, loyalty point information, gift card information, and the like. The data store component 144 may include an online database, hard drive, network attached storage (NAS), or clusters/tiers of these types of data storage devices. The vending system 100 may back up and distribute this data for resiliency and to maintain satisfactory up time in a variety of circumstances (e.g., high load).

The vendor application 150 is a software application run by the vendor that the vendor uses to access the vending system 100. The vendor application 150 may be a mobile application, such as an Apple iOS or Android application, a web-based application, a Windows application, or any other type of application accessible by the vendor to provide features described herein. The vendor may use a desktop computer, laptop computer, tablet computer, smartphone, or any other type of computing device associated with the vendor's business that can access the vending system 100 and run the vendor application 150. The vendor application 150 is responsible for the vendor's side of the communication with the vending system 100, including identifying who the vendor is and accessing any stored vendor profile with items/reports/payments/loyalty programs, providing information on currently visiting customers, allowing the vendor to add menu or other item information, allowing the vendor to receive and run reports on payments, receive customer orders, provide status updates to the customer, receive summon requests from the customer, and so on.

The vendor identifying component 151 identifies the vendor when the vendor runs the vendor application 150. Identifying the vendor includes accessing a vendor profile stored by the vending system and authenticating the vendor. The vendor may also go through an additional verification step initially to verify that the vendor owns or controls the business location that they say they do, such as by sending a letter in the mail with a verification code or by calling the vendor's business phone with a verification code.

Authenticating the vendor includes using available information to determine that the vendor is who he or she claims to be, to avoid fraudulent transactions or access to the vendor's profile by someone other than the vendor. Authentication may include using custom hardware of the vendor's device, such as Apple Face ID, Apple Touch ID, password, biometric information (voiceprint, fingerprint, retina scan, and so on), two-factor authentication (e.g., texting a code to a phone number associated with the customer), and so forth. Once the vendor is identified and authenticated, the vendor application 150 can present the vendor's profile to the vendor and offer options for interacting with customers.

The vendor profile component 152 stores persistent information related to the vendor and describing payments accepted by the vendor. The vendor profile may include items sold by the vendor to be presented to customers, payment history of payments received from customers, sales reports, vendor preferences (e.g., which features are enabled like customer ordering, status updates, payment types accepted, loyalty program options, and summoning), and so forth. The vendor profile determines the various ways that customers can interact with the vendor through the vending system 100.

The item update component 152 optionally provides a user interface to the vendor for adding and updating items sold by the vendor and offered to the customer through the vending system 100. The item update component may allow the vendor to provide an item name, description, pricing information, product image, options for customizing the item, times the item is available (e.g., breakfast items versus lunch or dinner items), and so forth.

The payment history component 153 allows the vendor to access a historical log of past payments received by the vending system 100 from customers. The component 153 may provide a variety of useful reports to the vendor, such as reporting on popular/most sold items, times during which items sell well, customer demographic slicing of sales, types of payments preferred by customers, and so on. The vendor may also receive payments through the system 100 into a system-managed account, and then transfer this money to a vendor account, such as via electronic funds transfer (EFT) or automated clearing house (ACH) payment to the vendor's bank account. In some embodiments, the system 100 may allow the vendor to set transfers up to happen automatically as payments come in or when a balance is reached.

The offer receiving component 154 optionally receives discount offers from the vendor to offer to customers. Discount offers may include coupons for an amount off an item, buy one get one (BOGO) offers, offers for the customer to use loyalty points to pay for an item, and so forth. The offers may include an expiration time or other conditions for using the offer. In some cases, an offer may apply to some types of customers but not others (e.g., frequent visitors, customers that previously purchased an item, and so on).

The computing device on which the vending system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, tablet computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform tasks or implement abstract data types. Typically, the functionality of the program modules may be combined or distributed as desired in various embodiments.

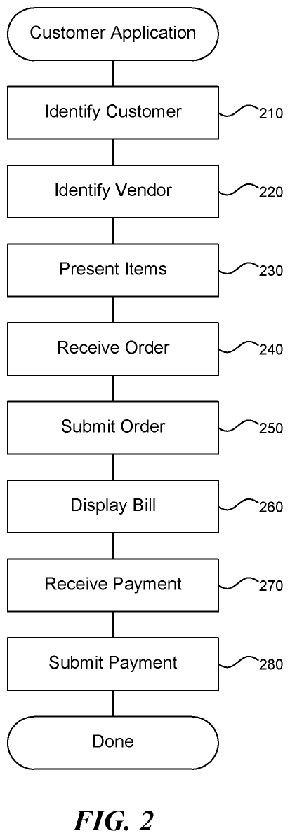

FIG. 2 is a flow diagram that illustrates processing of the vending system to interact with a customer through a customer software application running on a mobile device of the customer, in one embodiment. Beginning in block 210, the system identifies the customer by authenticating the customer on the customer's mobile device. Authentication may include asking the customer for a username, password, biometric information, two-factor authentication, or other method of authentication that distinguishes one customer from another to the system. When the customer has installed the customer application on his or her mobile device and regularly runs the application, the application may rely on a previous authentication and store credentials to use for authentication when the customer runs the application again. The username of the customer may be the customer's email address, or another unique name selected by the customer or system. When customer's first use the system, the system performs a registration step during which the customer initially identifies his or herself to the system, selects or is assigned a username, provides a password or other credentials, and may be verified such as by sending an email link that the user clicks to verify his or her email address.

Continuing in block 220, the system identifies a vendor that the customer is currently visiting. The vendor may be identified by the customer's current location, such as by accessing GPS, Bluetooth, NFC, camera, or other hardware and software of the customer's mobile device. Location may be detected automatically, or the customer may be asked to perform a manual step, such as scanning a QR code or other image at the vendor's business location. Where there is confusion as to which vendor the customer is visiting, the system may present a list of possible vendors the customer is visiting and allow the customer to choose the desired vendor from the list to resolve any ambiguity. Where the customer is ordering in advance of visiting the vendor or is requesting delivery of items from the vendor, the customer may identify the vendor by typing the vendor's name in a search user interface of the customer application or may select from a list of past vendors the customer has purchased from.

Continuing in block 230, the system optionally presents a menu of items available for the customer to purchase from the vendor. While some vendors may not choose to allow ordering through the vending system, others may provide a complete or partial menu of items that customers can choose from. In this way, a customer can place an order without waiting for a waitperson or other representative of the vendor to visit the customer in person. This can reduce delays for the customer, reduce errors in getting the customer's order right, inform the customer of options the customer may not have been aware of, and empower the customer. The menu may include a description of each item, a product image displayed to the customer, a quantity of items the customer can select, and any possible customizations available for the items (e.g., no dressing, sauce on the side, etc.).

Continuing in block 240, the system receives an order from the customer including a selection of one or more items from the presented menu of items. The order may include a quantity of each item and customizations for each item. The order may also indicate when to bring each item, such as an appetizer to be brought early, followed by dinner items, followed by dessert items later. Vendors may dynamically update items to indicate daily specials or items that have run out of stock and are not available. In the case of a remote order, the order may include a time that the customer wants the order delivered or plans to pick up the order, as well as a location to which to deliver the order. Orders may also include gratuity information, such as for delivered orders where a driver will bring the order.

Continuing in block 250, the system submits the order to the vendor so that the vendor may begin preparing the order for delivery to the customer. Submitting the order sends the order from the customer application to the vending backend, where the order may be stored in the data store for later analysis. The vending backend finds the correct vendor and sends the order to the vendor application being run by that vendor. The vendor application notifies the vendor of the order and may provide a paper copy of the order, such as through a ticker tape or other printed copy of the order that may then be submitted to the vendor's kitchen or other staff for fulfillment of the order. The vendor may then update status information to confirm that the order has been received, indicate to the customer that the order is being prepared, and provide a time estimate for completion of the order.

Continuing in block 260, the system receives a request to access a bill associated with the customer, so that the customer can provide payment. The request may occur manually, such as through the customer opening the customer application and indicating he or she is ready to settle the bill, or automatically, such as by the customer application detecting that the customer is leaving the vendor's business location and determining that automatic payments have been authorized by the customer. In the manual case, the customer application displays the bill to the customer including a total amount due and may also allow the customer to enter optional amounts such as a gratuity. The bill may also include sales tax information. In the automatic case, the customer application may access the customer's profile to determine a method of payment to use and an automatic gratuity to apply.

Continuing in block 270, the system receives a selection of a payment method to apply to pay the bill and an authorization from the customer to pay the bill using the selected payment method. Payment methods may include credit cards, gift cards, bank accounts (e.g., using EFT/ACH), loyalty points, digital payments (e.g., Apple Pay or Google Pay), or any other method of transferring value from the customer to the vendor. The customer may setup payment methods when registering with the vending system or at any time later when the customer needs to add or edit payment methods, such as to add a new credit card, update a credit card expiration date, and so forth. The customer authorizes the payment by confirming that the customer wants to make the payment and may also provide biometric information or reenter a password to confirm the payment. In some embodiments, vendors may select the level of security to apply to payments so that more sensitive products or amounts may have a higher requested level of confirmation.

Continuing in block 280, the system submits a payment from the customer to the vendor using the customer's selected payment method. Submitting the payment may include using a credit card API to perform a credit transaction, using a banking API to submit an EFT or ACH payment, deducting a gift card or loyalty points account, using a digital payments API to submit a digital payment, and so on. Submitting the payment transfers value from the customer to the vendor and settles the customer's bill. Upon submitting payment, the vendor may receive a notification of the payment in the vendor application. After block 280, these steps conclude.

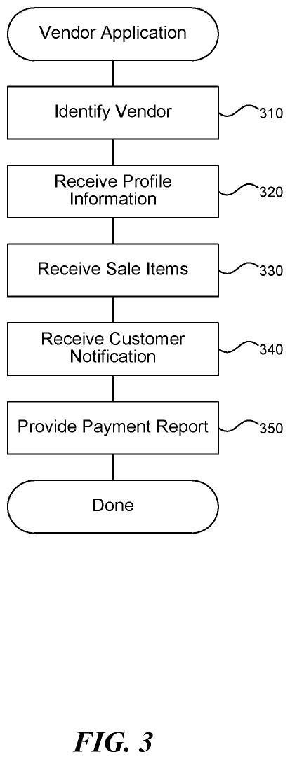

FIG. 3 is a flow diagram that illustrates processing of the vending system to interact with a vendor through a vendor software application, in one embodiment. Beginning in block 310, the system identifies the vendor running the vendor software application. The system may identify the vendor by asking the vendor to login using a previously registered username and password or other authentication information such as biometric authentication. If the vendor regularly uses the vendor application the vendor application may automatically identify the vendor by using saved credentials previously entered by the vendor. The vendor application may be run on any computing device of the vendor such as a desktop computer, laptop computer, mobile computing device, and so forth. The vendor may be initially identified based on the vendor's location as detected by GPS or other hardware, and the vendor may be asked to perform secondary validation to prove that the vendor is associated with the business at that location. This may include mailing or calling the vendor or other methods to prove that the vendor controls the indicated business.

Continuing in block 320, the system receives vendor profile information provided by the vendor that includes a description of a business location of the vendor. The vendor profile indication may indicate a type of business (e.g., restaurant, retail store, bar, etc.), a description of the business, a business image to be displayed when customer's view the business in the customer application, and so on. The vendor may provide initial profile information and may periodically update the profile information as needed.

Continuing in block 330, the system optionally receives a list of items for sale by the vendor. The entry for each item may include a description of the item, an item type (food, drink, other), product image, customizations available for the item, a minimum or maximum quantity of the item, and so forth. Vendors may update the list of available items and even provide a day by day indication of special items, out of stock items, and so forth.

Continuing in block 340 the vendor receives a notification from the vending system indicating an action taken by a customer. The vendor receives the notification without having any custom hardware installed to interact with the customer. The customer uses the customer's own mobile device brought with the customer and the vendor receives notifications through the vendor's existing devices, such as a computer or through integration with the vendor's existing POS system. The notification may be an indication of a customer order, a customer request to summon a representative of the vendor, a customer payment received, and so on.

Continuing in block 350, the system provides a payment report to the vendor that lists payments made by one or more customers to the vendor through the vending system. The system may allow the vendor to sort and filter payments to generate reports that are useful to the vendor, such as for determining what products are most popular, what type of customers order each product, times of day that each product is ordered, and so forth. After block 350, these steps conclude.

In some embodiments, the system protects vendors from non-payment by asking customers to agree to automatic payment when using the system. It is not uncommon for a customer to inadvertently leave a bar or restaurant today and forget to pay. This is often handled today by a bartender collecting the customer's license or credit card to open a tab. In this way, the vendor can either charge the credit card or collect payment when the customer returns for his or her card. Using the vending system, a similar reassurance can be provided to the vendor by allowing automatic payment if the customer leaves without paying. The system may also provide a process through which customers can dispute payments and vendors can substantiate why charges were made. Both vendor and customer may agree to participate in this arbitration when signing up to use the system.

From the foregoing, it will be appreciated that specific embodiments of the vending system have been described herein for purposes of illustration, but that various modifications may be made without deviating from the spirit and scope of the invention. Accordingly, the invention is not limited except as by the appended claims.

1. A computer-implemented method to interact with a customer visiting a vendor's business through a customer software application running on a mobile device of the customer, the method comprising:
identifying the customer by authenticating the customer on the customer's mobile device;
identifying the vendor that the customer is currently visiting without interacting with an employee of the vendor or a vendor device;
receiving a request to access a bill associated with the customer, so that the customer can provide payment without interacting with an employee of the vendor or a vendor device;
receiving a selection of a payment method to apply to pay the bill and an authorization from the customer to pay the bill using the selected payment method; and
submitting a payment from the customer to the vendor using the customer's selected payment method, wherein the payment is completed without interacting with an employee of the vendor or a vendor device in a manner that saves the customer time that would otherwise be spent waiting for the vendor,
wherein the preceding steps are performed by at least one processor.

2. The method of claim 1 wherein authenticating the customer comprises asking the customer for a username, password, biometric information, two-factor authentication, or other method of authentication that distinguishes one customer from another.

3. The method of claim 1 wherein authenticating the customer comprises during the customer's first use of the customer software application, performing a registration step during which the customer initially identifies his or herself, selects a username, and provides authentication credentials.

4. The method of claim 1 wherein identifying the vendor comprises automatically detecting the customer's current location by accessing GPS, Bluetooth, NFC, camera, or other hardware and software of the customer's mobile device.

5. The method of claim 1 wherein identifying the vendor comprises asking the customer to scan a QR code or other image at the vendor's business location.

6. The method of claim 1 wherein identifying the vendor comprises when the customer is ordering in advance of visiting the vendor or is requesting delivery of items from the vendor, the customer identifies the vendor by typing the vendor's name in a search user interface of the customer software application.

7. The method of claim 1 further comprising after identifying the vendor and before displaying the bill:
presenting a menu of items available for the customer to purchase from the vendor,
receiving an order from the customer including a selection of one or more items from the presented menu of items, and
submitting the order to the vendor so that the vendor may begin preparing the order for delivery to the customer without the customer interacting with a waitperson of the vendor.

8. The method of claim 1 wherein receiving the request to access the bill comprises detecting that the customer opened the customer application and indicated that he or she is ready to settle the bill.

9. The method of claim 1 wherein receiving the request to access the bill comprises automatically detecting that the customer is leaving the vendor's business location and determining that automatic payments have been authorized by the customer.

10. The method of claim 1 wherein receiving the selection of the payment method comprises receiving from the customer a selection of loyalty points earned by the customer through previous usage of the customer software application.

11. The method of claim 1 wherein submitting the payment comprises submitting the payment using a credit card application programming interface to perform a credit transaction, using a banking application programming interface to submit an electronic funds transfer or automated clearing house payment, deducting a gift card or loyalty points account, or using a digital payments application programming interface to submit a digital payment, wherein submitting the payment transfers value from the customer to the vendor and settles the customer's bill.

12-20. (canceled)
